(19) United States
(12) Patent Application Publication
(10) Pub. No.: US 2010/0056671 A1
(43) Pub. Date: Mar. 4, 2010

(54) POLYFUNCTIONAL EPOXY OLIGOMERS

(75) Inventor: Stephen M. Dershem, San Diego, CA (US)

Correspondence Address: The Law Office of Jane K. BABIN,;Professional Corporation, c/o Intellevate, P.O. Box 52050, Minneapolis, MN, 55402, US

(73) Assignee: DESIGNER MOLECULES, INC., San Diego, CA (US)

(21) Appl. No.: 12/595,589

(22) PCT Filed: Apr. 14, 2008
(86) PCT No.: PCT/US08/60278

§ 371 Date: Oct. 12, 2009

Related U.S. Application Data
(60) Provisional application No. 60/922,954, filed on Apr. 12, 2007.

(51) Int. Cl. C09J 163/00; C08G 65/04; C08F 124/00

(52) U.S. Cl. 523/400; 528/421; 526/273; 526/258

(57) ABSTRACT

The present invention provides epoxy functional oligomeric compounds, methods of preparation and uses therefor. In particular, the present invention provides to oligomeric epoxy compounds derived from allyl glycidyl ether.

### RELATED APPLICATIONS

The present application claims the benefit of priority under 35 U.S.C. §119 to U.S. Provisional Application No. 60/922,954 filed Apr. 12, 2007, the contents of which are incorporated herein by reference in its entirety.

### FIELD OF THE INVENTION

The present invention relates to oligomeric compounds, methods of preparation and uses therefor. In particular, the present invention relates to oligomeric epoxy compounds derived from allyl glycidyl ether.

### BACKGROUND OF THE INVENTION

Adhesive compositions are used for a variety of purposes in the fabrication and assembly of semiconductor packages and microelectronic devices. The more prominent uses include bonding of electronic elements such as integrated circuit chips to lead frames or other substrates, and bonding of circuit packages or assemblies to printed wire boards.

Adhesives used in the electronic packaging industry typically contain a thermosetting resin combined with a filler and some type of curing initiator. These resins are primarily used in the electronics industry for the preparation of non-hermetic electronic packages. Adhesives useful for electronic packaging applications typically exhibit such properties as good mechanical strength, cures that do not affect the function of the component or the carrier, and thixotropic properties compatible with application to microelectronic and semiconductor components. Examples of such packages are ball grid array (BGA) assemblies, super ball grid arrays, IC memory cards, chip carriers, hybrid circuits, chip-on-board, multi-chip modules, pin grid arrays, and the like.

Due to their adhesive strength and versatility, epoxy resins have been widely used in the semiconductor packaging industry. Indeed, epoxy resins often offer superior electrical properties, very high heat and chemical resistance, dimensional stability, low cure shrinkage, and durability. Nevertheless, the current and future requirements of the electronics industry will undoubtedly require materials, structures and methods having precise, determined properties and/or features that might not otherwise be available.

Thus, there is a continuing interest in the development of epoxy resins with both expanded properties and finely tuned characteristics, not only for current and future applications in semiconductor packaging applications, but also for applications such as bonding metals, for laminating and filling fiberglass, and in composite structures, for maintenance repairs, and patching applications.

### SUMMARY OF THE INVENTION

The present invention provides an oligomeric epoxy compound having the structure:

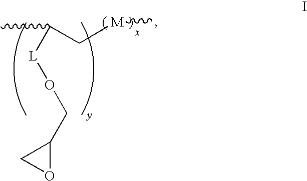

where each M is independently a monomer selected from an acrylate; a methacrylate, a styrenic, a maleimide, a vinyl ester, a vinyl ether, a fumarate, a maleate, an itaconate, a norbornene, a dicylcopentadiene, an indene, an olefin, a cyclic olefin, an allyl oxetanyl ether, a vinyl oxetanyl ether, an oxetanyl, an acrylate, a methacrylate, an acrylonitrile, a methacrylonitrile, an acrylamide, a methacrylamide a N,N-dimethyl acrylamide, and a phenyl acetate; L is an alkylene, oxyalkylene, cycloalkylene or is absent; and each x and y is independently 3 to about 100.

In certain embodiments, the at least one M is a cyclic olefin (such as a norbornene, a norbornadiene, or an oligomer of cyclopentadiene, which can be e.g. a dicyclopentadiene or a tetracyclododecene), a styrenic, an acrylate or a methacrylate. In other embodiments, the at least one M is an acetoxystyrene, a 4-acetoxyphenethyl acrylate, or a 4-acetoxyphenethyl vinyl ether. In yet further embodiments, the at least one M is a styrenic, such as 4-tert-butylstyrene.

The at least one M can also be a 2-hydroxyethyl acrylate, a 2-hydroxyethyl methacrylate, a hydroxypropyl acrylate, a hydroxypropyl methacrylate, a 4-hydroxybutyl acrylate, a 2-hydroxyethyl acrylamide, a 2-hydroxyethyl methacrylamide, an N-methylol methacrylamide, glycidyl methacrylate, a glycidyl vinyl ether, a (3-ethyl-3-oxetanyl)acrylate, a (3-ethyl-3-oxetanyl)methacrylate, a (3-ethyl-3-oxetanyl)vinyl ether, a (3-ethyl-3-oxetanyl)allyl ether, a furfuryl acrylate, a cyclohexanedimethanol monovinyl ether, a butanediol monovinyl ether, or a furfuryl methacrylate.

In certain aspects of the oligomeric epoxy compound, each x and y is independently about 20 to about 75. In other aspects, L has 2 to about 20 carbon atoms.

In still further aspects, the oligomeric epoxy compound is a block co-oligomer, a random co-oligomer, or an alternating co-oligomer. Thus, for example, the following non-limiting configurations of the oligomeric epoxy compounds of the invention are contemplated:

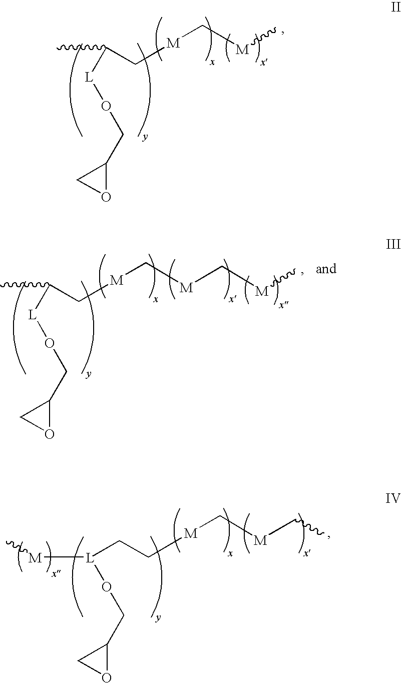

where each M is independently a monomer selected from an acrylate; a methacrylate, a styrenic, a maleimide, a vinyl ester, a vinyl ether, a fumarate, a maleate, an itaconate, a norbornene, a dicylcopentadiene, an indene, an olefin, a cyclic olefin, an allyl oxetanyl ether, a vinyl oxetanyl ether, an oxetanyl, an acrylate, a methacrylate, an acrylonitrile, a methacrylonitrile, an acrylamide, a methacrylamide a N,N-dimethyl acrylamide, and a phenyl acetate; L is an alkylene, oxyalkylene, cycloalkylene or is absent; and each x, x′, x″ and y is independently 3 to about 100.

The skilled artisan will appreciate the ratios and configuration of epoxy and each M will depend on the composition and starting ratios of each monomer and ally glycidyl ether included in the synthesis. Thus, formulae II, III and IV are exemplary only and should not be considered as limiting the invention compounds.

According to the present invention compounds having the following formulae are provided:

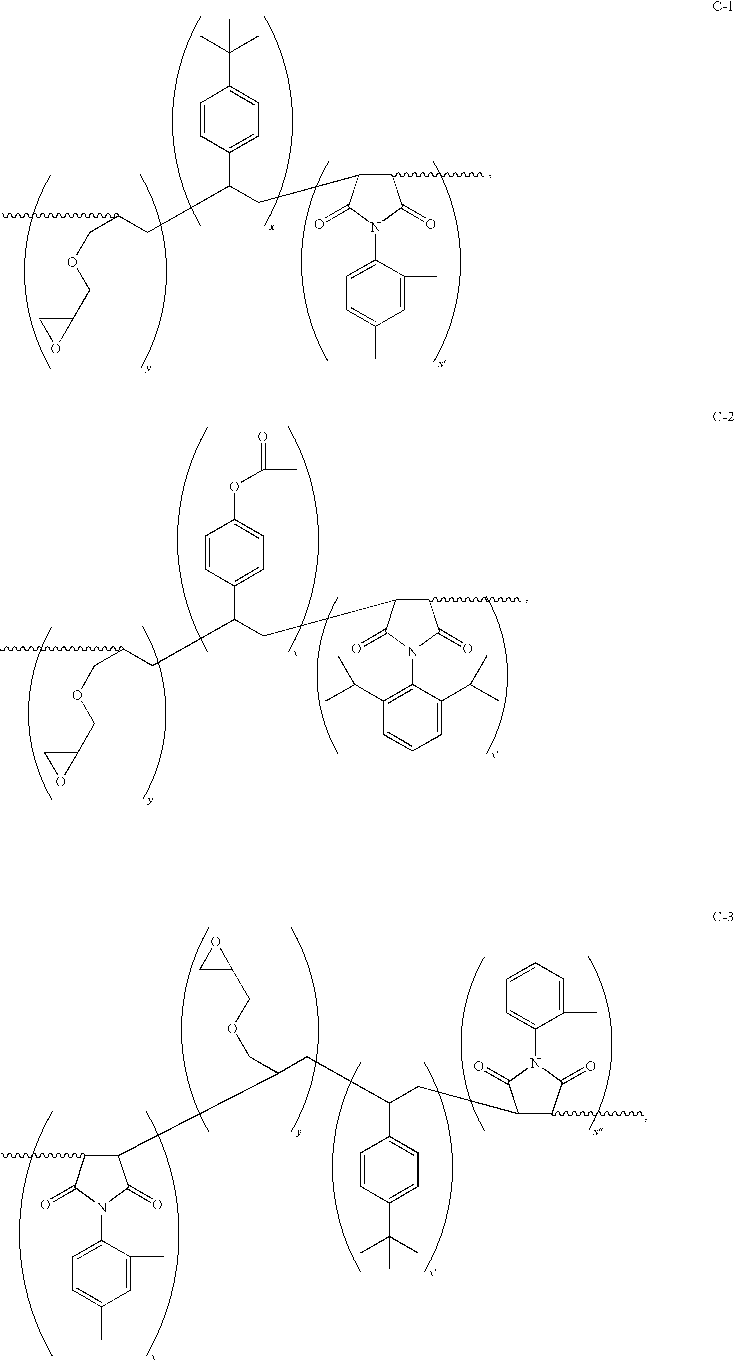

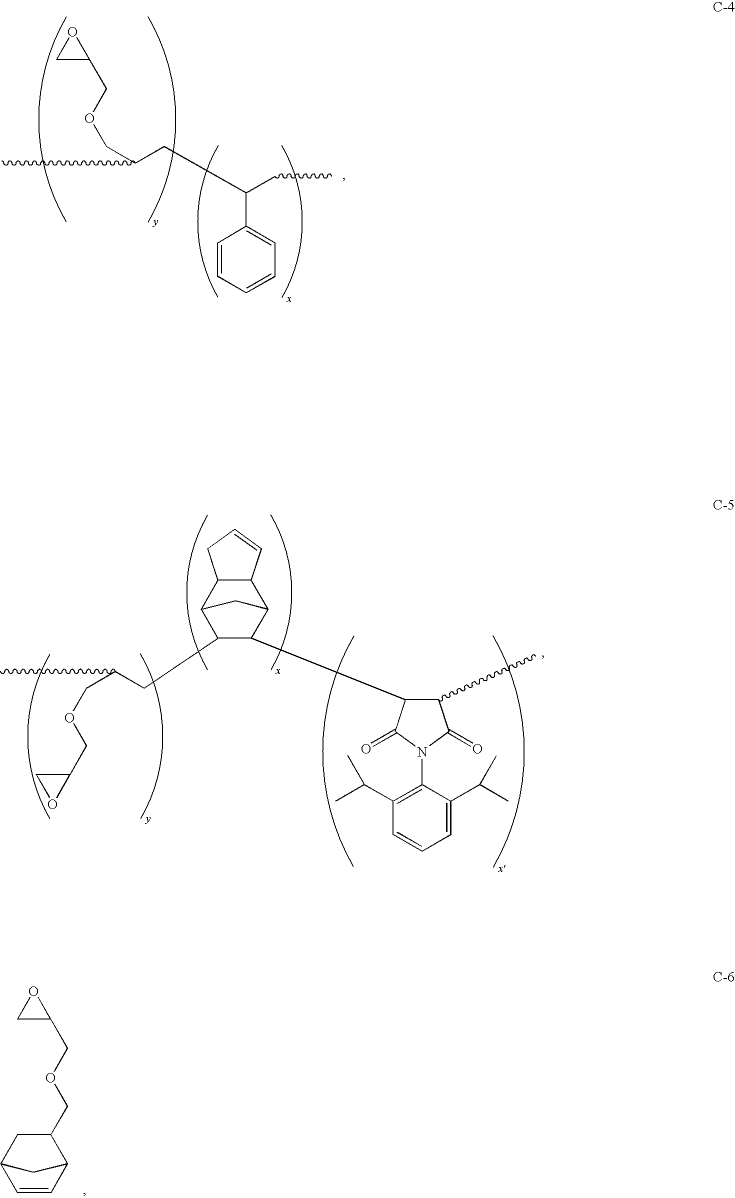

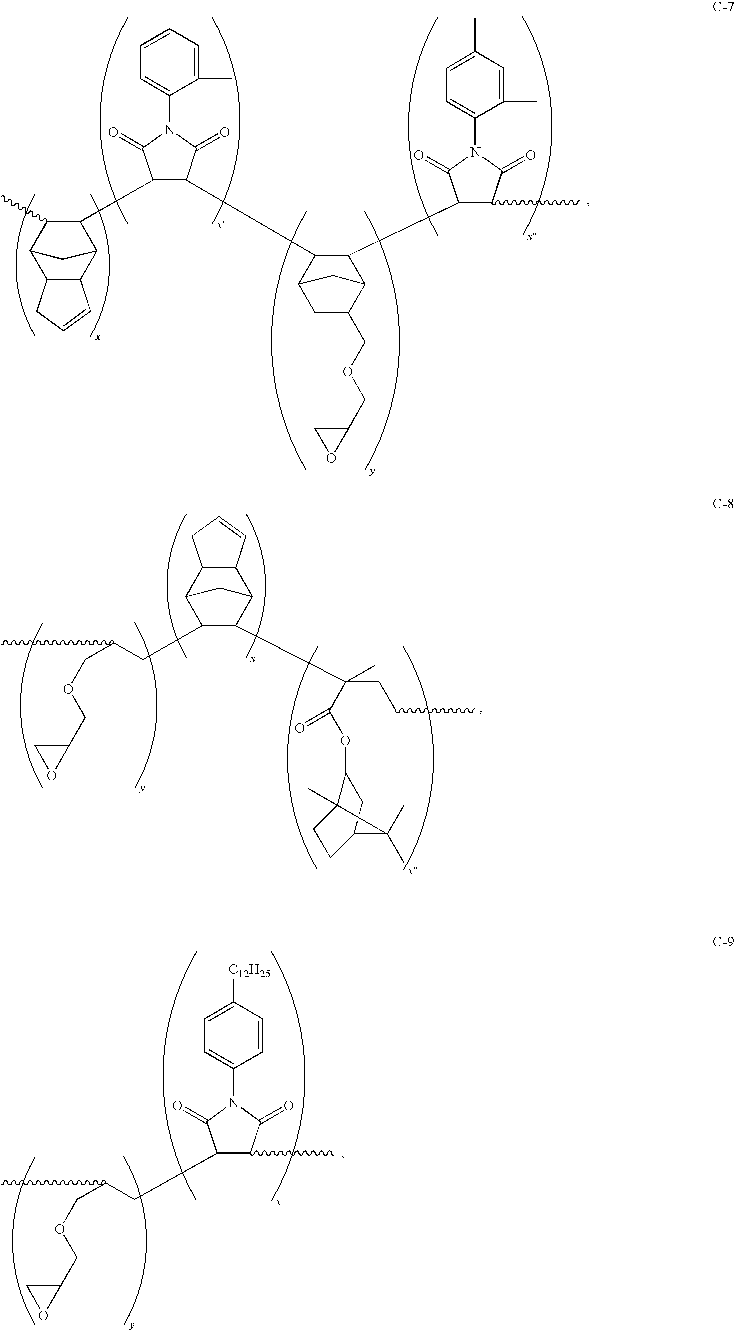

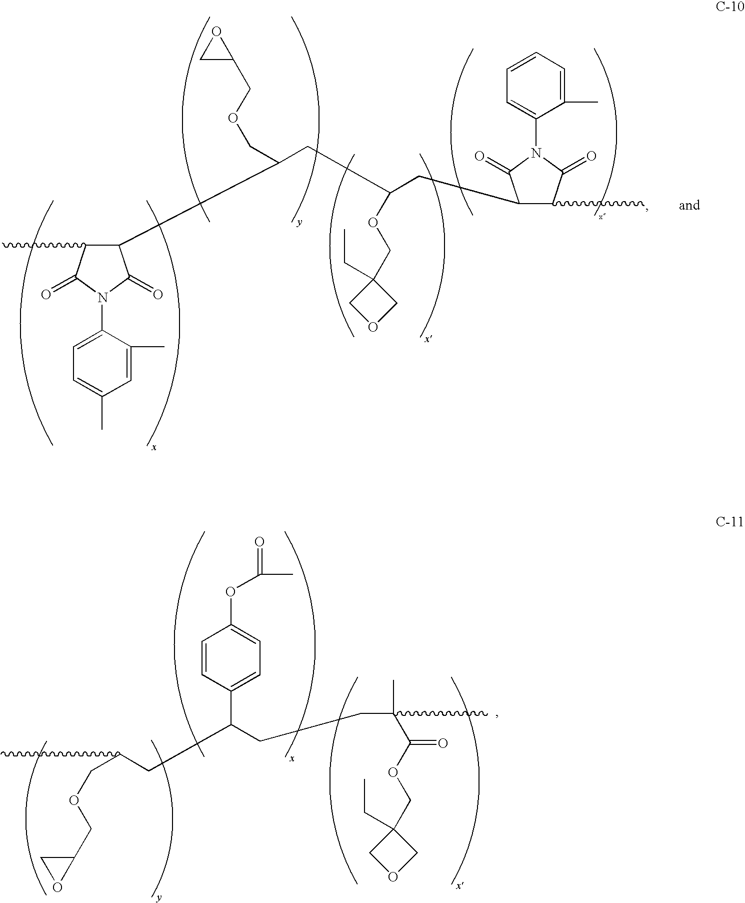

where each x and y is independently 3 to about 100.

Also provided by the invention are adhesive compositions, which include: at least one oligomeric epoxy compound of the invention, and 0.1 to about 5 wt % of at least one curing catalyst, based on the total weight of the composition. Such compositions may thermoset adhesives.

In certain embodiments of the invention, the adhesive composition contains about 0.5 to about 98 wt %; about 10 to about 85 wt %; or about 25 to about 50 wt % of at least one oligomeric epoxy compound of the invention.

The at least one curing catalyst can in certain aspects of the adhesive compositions of the invention, be 0.5 to about 4 wt % of the composition. The at least one curing catalyst included in the adhesive compositions of the invention can be e.g., a tertiary amine, a quaternary ammonium compound, a phosphine, or a phosphonium compound. In other embodiments, the at least one curing catalyst is a triethylamine, a tripropylamine, a tributylamine, a N,N-dimethylbenzylamine, a dimethylaminopyridine, a DBU, a DABCO, a 2-methylimidazole, a N-methylmorpholine, an epoxy amine adduct, a benzyl trimethyl ammonium chloride, a tetrabutylammonium chloride, a triphenylphosphine, a tributylphosphine, a trilaurylphosphine, a trichlorobutylphosphine, a trinaphthylphosphine, an ethyltriphenylphosphonium chloride, an ethyltriphenylphosphonium bromide, an ethyltriphenylphosphonium iodide, an ethyltriphenylphosphonium phosphate, an ethyltriphenylphosphonium acetate acetic acid complex, a tetrabutylphosphonium chloride, a tetrabutylphosphonium bromide, a tetrabutylphosphonium iodide, a tetrabutylphosphonium phosphate, a tetrabutylphosphonium acetate acetic acid complex, a butyltriphenylphosphonium tetrabromobisphenate, a butyltriphenylphosphonium bisphenate, or a butyltriphenylphosphonium bicarbonate.

In yet further embodiments, the at least one curing catalyst is an alkali metal hydroxide or a Lewis acid; or it can be sodium hydroxide, potassium hydroxide, lithium hydroxide, a boron trifluoride etherate, a boron trifluoride amine salts, a tin carboxylate, or a zinc carboxylate.

The adhesive composition of the invention can also include about 10 wt % to about 90 wt % of at least one co-curing compound selected from an epoxy, an acrylate, a methacrylate, a maleimide, a poly-phenol compound, an anhydride, a dianhydride, a polyanhydride, an imide, a carboxylic acid, a dithiol, a polythiol, a phenol functional mono-maleimide, a bismaleimide, a polymaleimide, a mono-itaconate, a mono-maleate, a mono-fumarate, an acrylic acid, a methacrylic acid, a cyanate ester, a vinyl ether, a vinyl ester, a phenol functional ester, a urea, an amide, a polyolefin, a cyanoacrylate, an allyl functional compound, and a styrenic

In other embodiments, the co-curing compound is an epoxy of a glydicyl ether of an alcohol, an epoxy of a glydicyl ether of a phenol, an epoxy of a glydicyl ether of a bisphenol, an epoxy of a glydicyl ether of an oligomeric phenolic, an epoxy of a glydicyl ether of a phenolic novolac, an epoxy of a glydicyl ether of a cresolic novolac, a styrene-maleic anhydride co-polymer, an amine functional polyolefin, a carboxylic acid functional polyolefin, a hydroxy functional polyolefin, an epoxy functional polyolefin, an epoxy functional siloxane, a phenolic functional siloxane, a carboxylic acid functional siloxane, or thiol functional siloxane.

In certain aspects, adhesive compositions of the invention can also include other components such as a phototoinitiator and/or a thermal initiator; a reactive diluent, and/or at least one filler, such as an electrically conductive or thermally conductive filler, or a filler that modifies rheology.

The filler can, for example, include silver, nickel, copper, aluminum, palladium, gold, graphite, metal-coated graphite, graphite, aluminum nitride, silicon carbide, boron nitride, diamond dust, alumina, calcium carbonate, silica, fumed silica, alumina, and/or titanium dioxide.

In other embodiments, the adhesive composition can also include further at least one coupling agent, such as a silicate ester, a metal acrylate salt, a titanate, a zirconate, or a compound that contains a co-polymerizable group and a chelating ligand (for example, a co-polymerizable function selected from a vinyl moiety, a acrylate moiety, a methacrylate, a epoxy, a thiol, a anhydride, an isocyanate, and a phenol moiety; and a silicate ester function). In certain aspect, the coupling agent is aluminum methacrylate, titanium methacryloxyethylacetoacetate triisopropoxide, or poly(methoxyglycidylsiloxane).

Also provided by the invention is a b-stageable adhesive composition, which can, for example, include about 5 to about 95% of at least one oligomeric epoxy compound of the invention; about 0.5 to about 5 wt % of at least one curing catalyst; about 0.1 to about 2% wt % of a coupling agent; 0 to about 30% wt % of at least one monomer selected from an acrylate, a methacrylate, a maleimide, a vinyl ether, a vinyl ester, a styrenic compounds and an allyl functional compound; about 1 to about 10% wt % of a curative; about 0.1 to about 5% wt % of a photoinitiator; and about 1 to about 50% wt % of a reactive diluent.

In certain embodiments, the b-stageable adhesive composition includes about 10 to about 50% of at least one oligomeric epoxy compound of the invention.

Assemblies that include a first article permanently adhered to a second article by a cured aliquot of an adhesive composition of the invention are also provide, as well as articles containing a circuit board having a solder mask that includes than invention compound or composition deposited thereon.

Further provided by the invention are electronic components encased within an aliquot of the composition, which can thus be non-hermetic electronic packages.

Also provided by the invention are methods for adhesively attaching a first article to a second article, including the steps of applying an adhesive composition of the invention to the first article, the second article or both the first article and the second article; contacting the first article and the second article to form an assembly, with the first article and the second article are separated only by the applied adhesive composition; and curing the applied adhesive composition thereby adhesively attaching the first article to the second article.

According to the invention, methods for adhesively attaching a semiconductor device, such as a die, to a substrate include the steps of applying an invention adhesive composition to the substrate, the semiconductor device or both the substrate and the semiconductor device; contacting the substrate and the semiconductor device to form an assembly of parts separated only by the applied adhesive composition; and curing the applied adhesive composition, thereby attaching the semiconductor device to the substrate.

In yet further embodiments, the invention provides a method for adhesively attaching a semiconductor device, such as a die, to a substrate by (a) applying an adhesive composition of the invention to the substrate, the semiconductor device or both the substrate and the semiconductor device; (b) melting the applied adhesive composition; (c) contacting the semiconductor device and the substrate, such that the die and substrate are separated only by the applied adhesive composition; and curing the applied adhesive composition, thereby adhesively attaching the semiconductor device to the substrate.

### DETAILED DESCRIPTION

Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation. The foregoing techniques and procedures can be generally performed according to conventional methods well known in the art.

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described.

### DEFINITIONS

“About” as used herein means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms, although the term “alkyl” also includes instances where no numerical range of carbon atoms is designated).

As used herein, “oligomer” or “oligomeric” refers to a compound having a finite number of repeating structural units, or monomers. Oligomers of the invention typically have 2 to about 500 repeating monomer units; frequently 3 to about 300 repeating monomer units; and often 3 to about 100 repeating monomer units; and usually have a molecular weight up to about 10,000.

“Imide” as used herein, refers to a functional group having two carbonyl groups bound to a primary amine or ammonia. The general formula of an imide of the invention is:

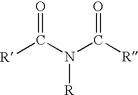

“Polyimides” are polymers of imide-containing monomers. Polyimides typically have one of two forms: linear or cyclic. Non-limiting examples of linear and cyclic (e.g. an aromatic heterocyclic polyimide) polyimides are shown below for illustrative purposes.

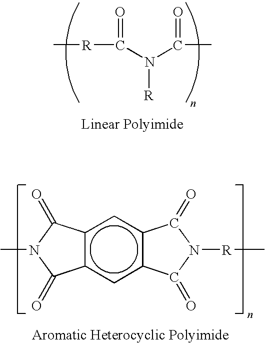

“Maleimide,” as used herein, refers to an N-substituted maleimide having the formula as shown below:

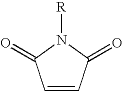

Wherein the “R” group may be an aromatic, herteroaromatic, aliphatic, or polymeric moiety.

As used herein, the term “acrylate” refers to a compound bearing at least one moiety having the structure:

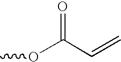

As used herein, the term “acrylamide” refers to a compound bearing at least one moiety having the structure:

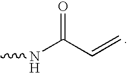

As used herein, the term “methacrylate” refers to a compound bearing at least one moiety having the structure:

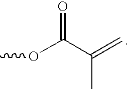

As used herein, the term “methacrylamide” refers to a compound bearing at least one moiety having the structure:

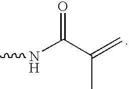

As used herein “epoxy” refers to a thermosetting epoxide polymer that cures by polymerization and crosslinking when mixed with a catalyzing agent or “hardener,” also referred to as a “curing agent” or “curative.” Epoxies of the present invention include, but are not limited to aliphatic, cycloaliphatic, glycidyl ether, glycidyl ester, glycidyl amine epoxies, and the like, and combinations thereof. Epoxies of the invention include compounds bearing at least one moiety having the structure:

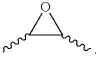

As used herein, the term “vinyl ether” refers to a compound bearing at least one moiety having the structure:

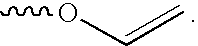

“Glass transition temperature” or “Tg” is used herein to refer to the temperature at which an amorphous solid, such as a polymer, becomes brittle on cooling, or soft on heating. More specifically, it defines a pseudo second order phase transition in which a supercooled melt yields, on cooling, a glassy structure and properties similar to those of crystalline materials e.g. of an isotropic solid material.

“Thermoplastic,” as used herein, refers to the ability of a compound, composition or other material (e.g. a plastic) to melt to a liquid when heated and freeze to solid, often brittle and glassy, state when cooled sufficiently.

“Thermoset,” as used herein, refers to the ability of a compound, composition or other material to irreversibly “cure” to a stronger, harder form. Thermoset materials are typically polymers that may be cured, for example, through heat (e.g. above 200 degrees Celsius, or less than 200° C. in the presence of a suitable catalyst), via a chemical reaction (e.g. epoxy), or through irradiation (e.g. U.V. irradiation).

Thermoset materials, such as thermoset polymers or resins, are typically liquid or malleable forms prior to curing, and therefore may be molded or shaped into their final form, and/or used as adhesives. Curing transforms the thermoset resin into a rigid infusible solid or rubber by a cross-linking process. Thus, energy and/or catalysts are added that cause the molecular chains to react at chemically active sites (unsaturated or epoxy sites, for example), linking the polymer chains into a rigid, 3-D structure. The cross-linking process forms molecules with a higher molecular weight and resultant higher melting point. During the reaction, when the molecular weight of the polymer has increased to a point such that the melting point is higher than the surrounding ambient temperature, the polymer becomes a solid material.

As used herein, “b-stageable” refers to the properties of an adhesive having a first solid phase followed by a tacky rubbery stage at elevated temperature, followed by yet another solid phase at an even higher temperature. The transition from the tacky rubbery stage to the second solid phase is thermosetting. However, prior to thermosetting, the material behaves similarly to a thermoplastic material. Thus, such adhesives allows for low lamination temperatures while providing high thermal stability.

A “die” as used herein, refers to a small block of semiconducting material, on which a functional circuit is fabricated.

A “solder mask” is a layer of polymer, such as an thermoset polymer, that provides a protective coating e.g. for the copper traces of a printed circuit board (PCB) and prevents solder from bridging between conductors, thereby creating short circuits. Solder masks also provide protection from the environment. In certain embodiments, a solder mask of the invention is silkscreened through a pattern onto a PCB. In other embodiments, the solder mask is sprayed or vacuum laminated onto the PCB. Solder masks are typically cured after the pattern is defined.

### Oligomeric Epoxy Compounds

The present invention is based on the discovery that a wide variety of cross-linkable functional groups can be incorporated into epoxy oligomers, thereby making these multi-functional epoxy oligomers quite useful as thermosetting resin compositions. In particular, the present invention provides oligomers containing allyl glycidyl ether co-oligomerized with varied mono and dual functionalized monomers.

The present invention provides oligomeric epoxy compounds having the structure:

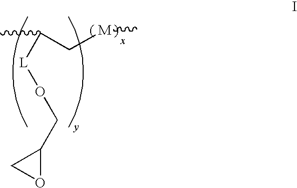

where each M is independently a monomer selected from an acrylate, a methacrylate, a styrenic, a maleimide, a vinyl ester, a vinyl ether, a fumarate, a maleate, an itaconate, an olefin, a cyclic olefin, an allyl oxetanyl ether, a vinyl oxetanyl ether, an oxetanyl(meth)methacrylate, an acrylonitrile, a methacrylonitrile, a N,N-dimethyl acrylamide, and a (meth)acrylamide; L is an alkylene, oxyalkylene, cycloalkylene or is absent; and each x and y is independently 3 to about 100.

In certain embodiments, L has 2 to about 20 carbon atoms. In other embodiments, L has 2 to about 10 carbon atoms. In yet further embodiments, L has 5 to 8 carbon atoms.

As shown in formula I above, the oligomeric epoxy compounds can have a variety of configurations, including random, alternating and block co-oligomers. Thus, for example, the following non-limiting configurations of the oligomeric epoxy compounds of the invention are contemplated:

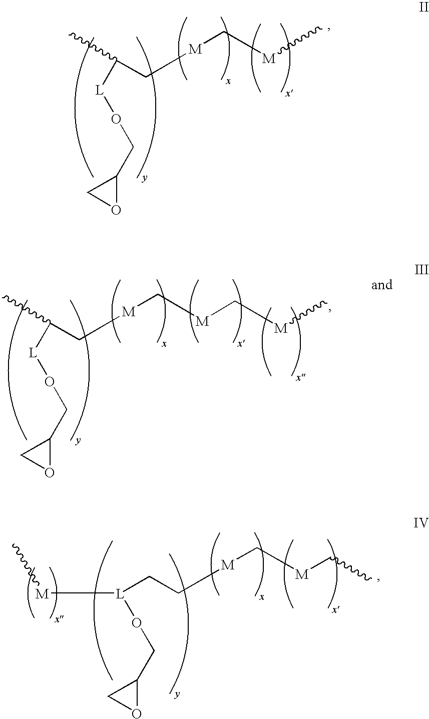

where each M is independently a monomer selected from an acrylate; a methacrylate, a styrenic, a maleimide, a vinyl ester, a vinyl ether, a fumarate, a maleate, an itaconate, a norbornene, a dicylcopentadiene, an indene, an olefin, a cyclic olefin, an allyl oxetanyl ether, a vinyl oxetanyl ether, an oxetanyl, an acrylate, a methacrylate, an acrylonitrile, a methacrylonitrile, an acrylamide, a methacrylamide a N,N-dimethyl acrylamide, and a phenyl acetate; L is an alkylene, oxyalkylene, cycloalkylene or is absent; and each x, x′, x″ and y is independently 3 to about 100.

The skilled artisan will appreciate the ratios and configuration of epoxy and each M substituents will depend on the composition and starting ratios of each monomer and ally glycidyl ether included in the synthesis. Thus, formulae II, III and IV are exemplary only and should not be considered as limiting the invention compounds.

The oligomeric epoxy compounds of the invention retain the reactivity of glycidyl ether epoxies because they are derived from allyl glycidyl ether (AGE). Thus, they can be cured using a variety of curatives, such as amines, anhydrides, phenols, or they can be subject to pure catalytic cures.

Allyl glycidyl ether is available in very high purity (e.g., from Ciba, Basel, Switzerland) versions and has very low chloride (less than 10 ppm total). Accordingly, allyl glycidyl ether does not contribute to chloride ion related corrosion of electronic components. The allyl functional group has another benefit in that it acts as its own chain terminator and thus the polymerization products can be limited to oligomeric species. This property has the practical benefit of providing compounds with low melt viscosities.

The epoxy equivalent weight (and therefore cross-link density) can be varied over a wide range depending on the ratios of monomers used to synthesize the epoxy oligomers. Generally, AGE is used in large excess in the preparation of the epoxy oligomers of the invention. However, almost all of the excess AGE can be recovered after the reaction is complete, so the reaction is efficient and commercially viable.

The AGE can also be converted to a cyclic olefin derivative and this monomer can be used in place of AGE itself to give even higher T_{g} oligomers. In principle, any monofunctional acrylate, methacrylate, styrenic, maleimide, vinyl ester, vinyl ether, fumarate, maleate, itaconate, norbornene, dicylcopentadiene, indene, olefin, cyclic olefin or the like could be co-cured with AGE. Other monomers contemplated for co-cure with the epoxy oligomers of the present invention include acrylonitrile, methacrylonitrile, acrylamide, methacrylamide, N,N-dimethylacrylamide, and the like.

Certain monomers cannot be used in the synthesis of the epoxy oligomers of the invention, such as those with amine, acid, anhydride, isocyanate, or thiol functionality. It is, however, possible to safely incorporate phenyl acetates (e.g. acetoxystyrene, 4-acetoxyphenethyl acrylate, and 4-acetoxyphenethyl vinyl ether).

Other dual functional monomers contemplated for use in the synthesis of epoxy oligomers of the invention include 2-hydroxyethyl acrylate, 2-hydroxyethyl methacrylate, hydroxypropyl acrylate, hydroxypropyl methacrylate, 4-hydroxybutyl acrylate, 2-hydroxyethyl acrylamide, 2-hydroxyethyl methacrylamide, N-methylol methacrylamide, glycidyl methacrylate, glycidyl vinyl ether, (3-ethyl-3-oxetanyl)acrylate, (3-ethyl-3-oxetanyl)methacrylate, (3-ethyl-3-oxetanyl)vinyl ether, (3-ethyl-3-oxetanyl)allyl ether, furfuryl acrylate, cyclohexanedimethanol monovinyl ether, butanediol monovinyl ether, and furfuryl methacrylate.

The particular monomer or combination of monomers used will depend on the properties that are desired in the end product. The mono-maleimides, for example provide the invention oligomers with a high T_{g}.

Representative, non-limiting examples of the compounds of the invention are shown in the following formulae:

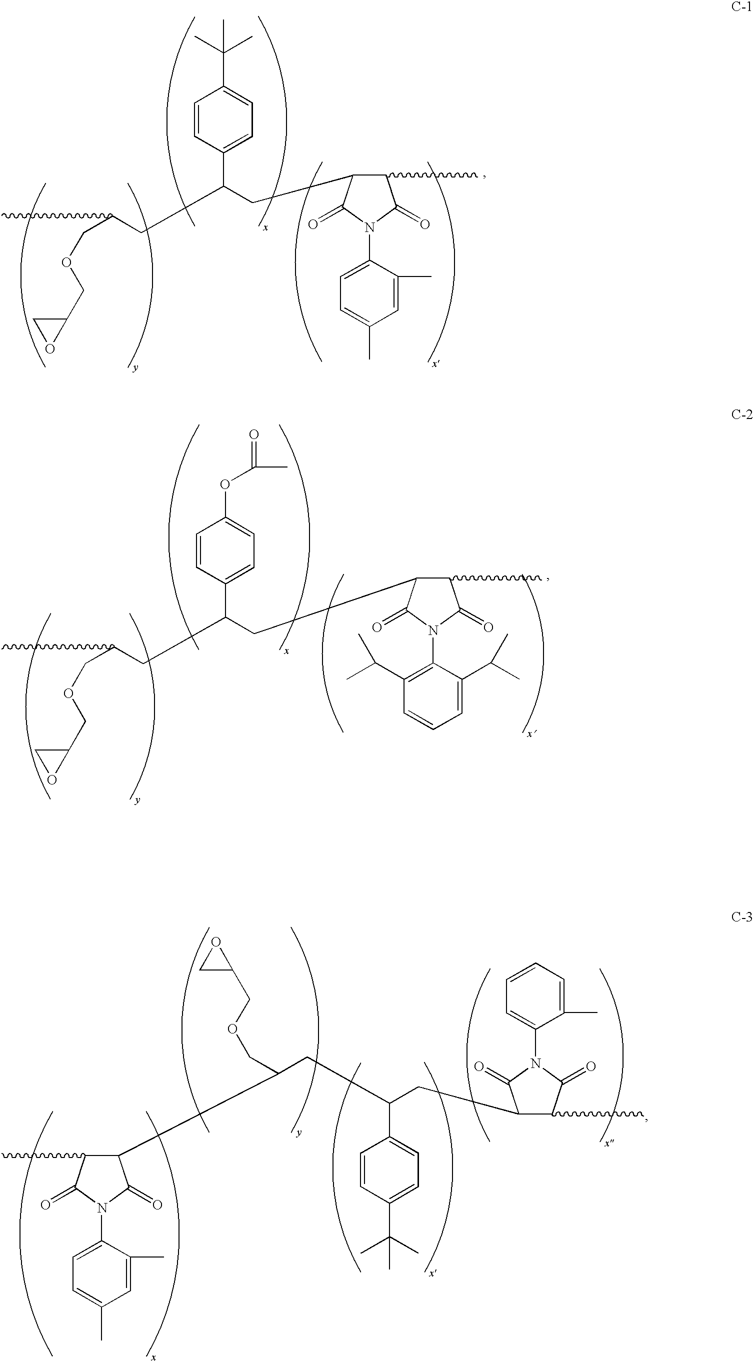

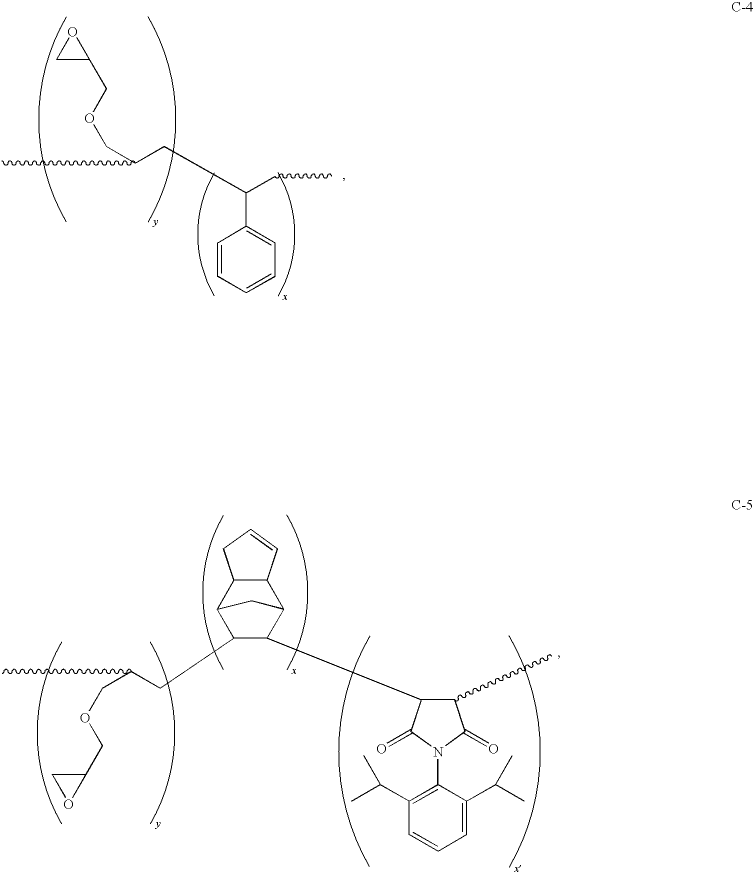

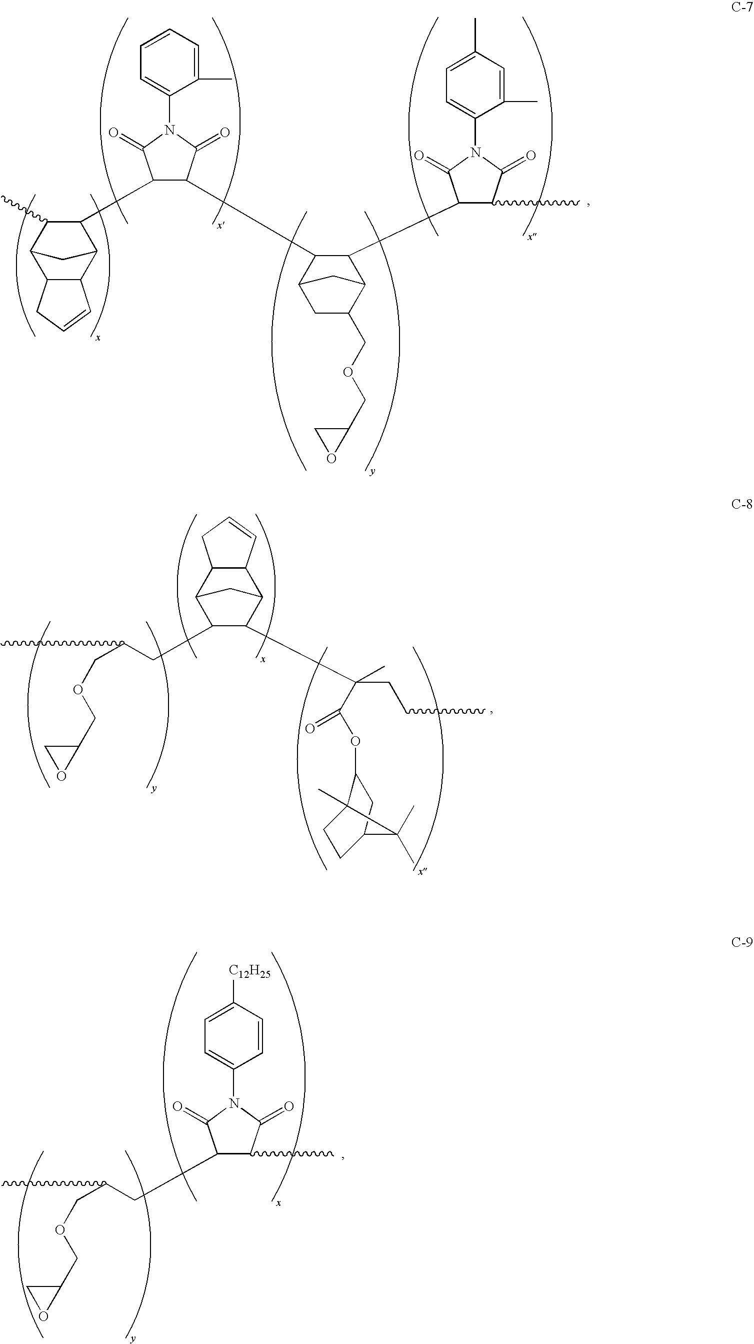

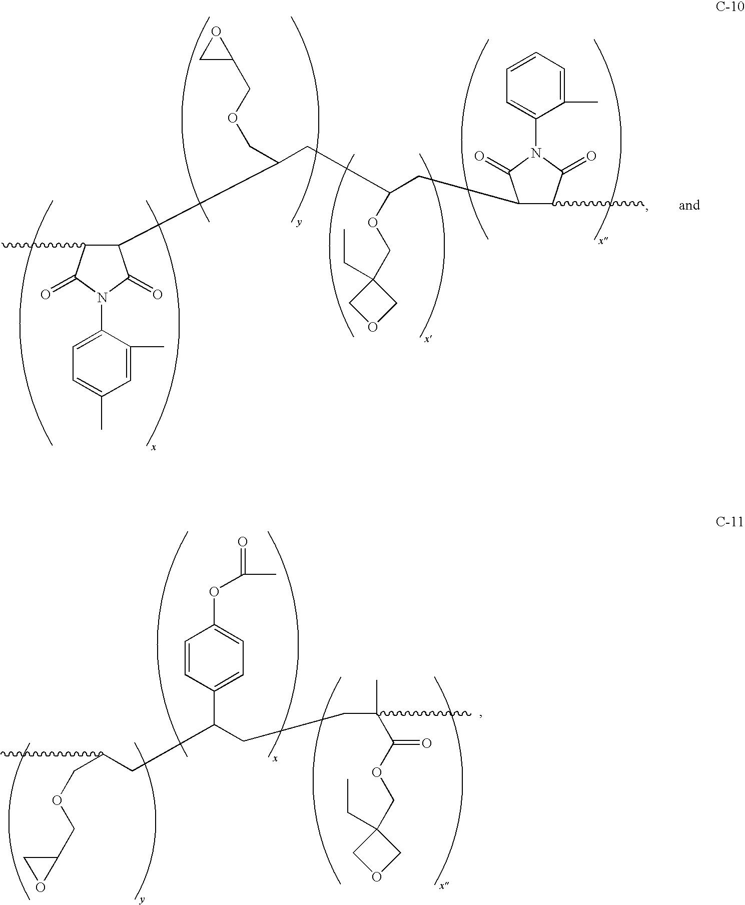

where each x, x′, x″ and y is independently 3 to about 100.

The oligomers are best formed at temperatures above 120° C. because higher temperatures reduce the selectivity against incorporation of AGE versus the other monomers. It is preferable to use free radical initiators with one-hour half-life temperatures greater than 100° C. These initiators include azo compounds such as 1,1′-azobis(cyclohexanecarbonitrile), and peroxides such as t-butyl peroxyisobutarate, t-butyl peroxyactate, t-butyl peroxybenzoate, dicumyl peroxide, t-butyl cumyl peroxide, di-t-butyl peroxide, and the like.

### Adhesive Compositions Containing Epoxy Oligomers

The present invention also provides adhesive compositions, such as thermosetting resin compositions, including at least one oligomeric epoxy compound of the invention described above.

In certain embodiments, the oligomeric epoxy compound is present at about 0.5 to about 98 weight percent of the adhesive composition. In other embodiments, the oligomeric epoxy compound is present at about 5 to about 95 weight percent of the adhesive composition. In yet other embodiments, the oligomeric epoxy compound contributes about 10 to about 85 weight percent of the adhesive composition. In yet further embodiments, the oligomeric epoxy compound is present at about 20 to about 75 weight percent of the adhesive composition. In still other embodiments, the oligomeric epoxy compound is present at about 25 to about 50 weight percent of the adhesive composition.

In certain embodiments, the adhesive composition includes about 0.1 to about 5 wt % of at least one curing catalyst, based on the total weight of the composition. In other embodiments, the curing catalyst is about 0.5 to about 4 wt % of the adhesive composition.

Additional Co-Curing Compounds. In certain aspects, the adhesive compositions of the invention include is at least one additional compound that can co-cure with the oligomeric epoxy compounds. The additional compound is typically present in the composition from about 10 wt % to about 90 wt % based on total weight of the composition. Such compounds include, for example, epoxies (e.g. epoxies based on glydicyl ethers of alcohols, phenols, bisphenols, oligomeric phenolics, phenolic novolacs, cresolic novolacs, acrylates, methacrylates, maleimides, poly-phenol compounds (e.g. poly(4-hydroxystyrene)), anhydrides, dianhydrides, polyanhydrides such as styrene-maleic anhydride co-polymers, imides, carboxylic acids, dithiols, polythiols, phenol functional mono-maleimides, bismaleimides, polymaleimides, mono-itaconates, mono-maleates, mono-fumarates, acrylic acid, methacrylic acid, cyanate esters, vinyl ethers, vinyl esters, or phenol functional esters, ureas, amides, polyolefins (e.g. amine, carboxylic acid, hydroxy, and epoxy functional) siloxanes (e.g. epoxy, phenolic, carboxylic acid, or thiol functional), cyanoacrylates, allyl functional compounds and styrenic, as well as combinations thereof.

Curing Catalysts. Catalysts suitable for use in the present invention are generally compounds that can be employed to catalyze the reaction between a phenolic hydroxyl group, a phenyl ester, an anhydride, or a thiol and a vicinal epoxide group. Such catalysts include, but are not limited to, tertiary amines such as, triethylamine, tripropylamine, tributylamine; N,N-dimethylbenzylamine, dimethylaminopyridine, DBU, DABCO, 2-methylimidazole (such as, for example, the Curezol™ imidazoles (available from Air Products and Chemicals, Allentown, Pa.), N-methylmorpholine, epoxy amine adducts such as any of the Anjicure® or Ancamine® catalysts (Ajinomoto U.S.A., Inc., Fort Lee, N.J.) and carboxylic acid salts thereof, quaternary ammonium compounds such as, benzyl trimethyl ammonium chloride, tetrabutylammonium chloride; phosphines such as triphenylphosphine, tributylphosphine, trilaurylphosphine, trichlorobutylphosphine, trinaphthylphosphine; and phosphonium compounds such as, ethyltriphenylphosphonium chloride, ethyltriphenylphosphonium bromide, ethyltriphenylphosphonium iodide, ethyltriphenylphosphonium phosphate, ethyltriphenylphosphonium acetate.acetic acid complex, tetrabutylphosphonium chloride, tetrabutylphosphonium bromide, tetrabutylphosphonium iodide, tetrabutylphosphonium phosphate, tetrabutylphosphonium acetate.acetic acid complex, butyltriphenylphosphonium tetrabromobisphenate, butyltriphenylphosphonium bisphenate, butyltriphenylphosphonium bicarbonate. Combinations of two or more catalysts are also contemplated by the present invention.

In addition, for applications outside the microelectronic packaging industry, catalysts contemplated for use include alkali metal hydroxides, such as sodium hydroxide, potassium hydroxide, lithium hydroxide, and combinations thereof. Lewis acids such as boron trifluoride etherates, boron trifluoride amine salts, tin carboxylates, and zinc carboxylates.

The invention can also so be carried out with thermal or photo initiated cationic catalysts including, but not limited to boron, antimony, or phosphorous based iodonium salts.

Photoinitiators. In some embodiments, both photoinitiation and thermal initiation may be desirable. For example, curing of a photoinitiator-containing adhesive can be started by UV irradiation, and in a later processing step, curing can be completed by the application of heat to accomplish the final cure. Both UV and thermal initiators may therefore be added to the adhesive compositions of the invention.

### Adhesive Paste Compositions Containing Epoxy Oligomers

In certain embodiments, the present invention provides adhesives that are of various consistencies including, liquids, gels, pastes and solids. In one embodiment, the adhesive composition is a paste suitable for attaching an electronics die to a substrate (i.e., die-attach pastes).

In one aspect, the invention provides a adhesive die-attach paste that includes 0.5 weight percent to about 98 weight percent (wt %) of at least one oligomeric epoxy compound of the invention, based on total weight of the composition; 0 to about 90 wt % of a filler; 0.1 wt % to about 5 wt % of at least one curing initiator, based on total weight of the composition; 0.1 wt % to about 4 wt %, of at least one coupling agent, based on total weight of the composition.

Fillers. Fillers contemplated for use in the practice of the present invention can be electrically conductive, and/or thermally conductive, and/or fillers which act primarily to modify the rheology of the resulting composition. Examples of suitable electrically conductive fillers which can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers which can be employed in the practice of the present invention include graphite, aluminum nitride, silicon carbide, boron nitride, diamond dust, alumina, and the like. Compounds that act primarily to modify rheology include calcium carbonate silica, fumed silica, alumina, titania, and the like.

Coupling Agents. As used herein, the term “coupling agent” refers to chemical species that are capable of bonding to a mineral surface and which also contain polymerizably reactive functional group(s) so as to enable interaction with the adhesive composition and/or die-attach paste. Coupling agents thus facilitate linkage of the die-attach paste to the substrate to which it is applied.

Exemplary coupling agents contemplated for use in the practice of the present invention include silicate esters, metal acrylate salts (e.g., aluminum methacrylate), titanates (e.g., titanium methacryloxyethylacetoacetate triisopropoxide), zirconates, or compounds that contain a copolymerizable group and a chelating ligand (e.g., phosphine, mercaptan, acetoacetate, and the like). In some embodiments, the coupling agents contain both a co-polymerizable function (e.g., vinyl moiety, acrylate moiety, methacrylate, epoxy, thiol, anhydride, isocyanate, phenol moiety, and the like), as well as a silicate ester function. The silicate ester portion of the coupling agent is capable of condensing with metal hydroxides present on the mineral surface of substrate, while the co-polymerizable function is capable of co-polymerizing with the other reactive components of invention die-attach paste. In certain embodiments coupling agents contemplated for use in the practice of the invention are oligomeric silicate coupling agents such as poly(methoxyglycidylsiloxane).

In general, the adhesive compositions and/or die-attach pastes will cure within a temperature range of 80-220° C., and curing will be effected within a period of time of less than 1 minute to 120 minutes. As will be understood by those skilled in the art, the time and temperature curing profile for each adhesive composition will vary, and different compositions can be designed to provide the curing profile that will be suited to the particular industrial manufacturing process.

Additional Compounds. In certain embodiments, the adhesive compositions and/or die-attach pastes may contain additional compounds, such as modifiers, that lend additional flexibility and/or toughness to the resultant cured adhesive. Such compounds may be any thermoset or thermoplastic material having a T_{g} of 50° C. or less, and typically will be a polymeric material characterized by free rotation about the chemical bonds, the presence of ether groups, and the absence of ring structures. Suitable modifiers include polyacrylates, poly(butadiene), polyTHF (polymerized tetrahydrofuran, also known as poly(1,4-butanediol)), CTBN (carboxy-terminated butadiene-acrylonitrile) rubber, and polypropylene glycol. When present, toughening compounds may be in an amount up to about 15 percent by weight of the total adhesive composition.

### Assemblies

In yet another embodiment of the invention, assemblies of components adhered together by the above-described adhesive compositions and/or adhesive die attach pastes are provided. Thus, for example, assemblies comprising a first article adhered to a second article by a cured aliquot of an adhesive composition containing an oligomeric epoxy compound of the invention are provided. Articles contemplated for assembly employing invention adhesives include electronic components such as dies, memory devices, ASIC devices, microprocessors, flash memory devices, and the like. Also encompassed by the invention are assemblies comprising a microelectronic device permanently adhered to a substrate by a cured aliquot of the above-described die attach paste. Microelectronic devices contemplated for use with invention die attach pastes include copper lead frames, Alloy 42 lead frames, silicon dice, gallium arsenide dice, germanium dice, and the like.

In yet another embodiment of the invention, the oligomeric epoxy compounds may be used in encasements, masks, coatings and the like. Thus, the present invention provides a circuit board having a solder mask made from or containing the adhesive compositions of the invention. In another embodiment, the invention provides electronic components encased within an aliquot of the epoxy oligomeric compounds or compositions of the invention. For example, the electronic component can be a non-hermetic electronic package.

The compositions of the invention include compositions useful as adhesives, coatings, matrix resins and composite resins. In certain embodiments, the composition is a die paste adhesive that includes a filler. In other embodiments, the composition is a industrial or marine coating that includes e.g., a filler, an extender and/or a pigment. Also contemplated by the invention are compositions including industrial, marine, automotive, airline, aerospace, sporting goods, medical and dental matrix resins. In yet other aspects of the invention, the compositions can be composite resins that include for example, carbon fiber, fiberglass and/or silica.

The present invention also provides: assemblies comprising a first article adhered to a second article by a cured aliquot of the adhesive composition described above; articles of manufacture coated with a cured layer of one of the compositions described above, such as a watercraft, automobile or airplane parts. In other embodiments of the invention, articles of manufactures can be comprised substantially of a cured amount of the composition described herein, such as an industrial, marine, automotive, airline, aerospace, sporting goods, medical or dental article. Such articles of manufacture can also include fillers, extenders, pigments and/or reinforcing materials along with the compositions disclosed herein.

### Methods of Using Oligomer Epoxy Compounds and Compositions

According to the present invention, methods for adhesively attaching a first article to a second article. Such methods can be performed, for example, (a) applying an adhesive composition of the invention to the first article, the second article or both the first article and the second article; (b) contacting the first article and the second article to form an assembly where the first article and the second article are separated only by the applied adhesive composition; and (c) curing the applied adhesive composition, thereby attaching the first article to the second article.

In certain embodiments, the invention provides methods for adhesively attaching a semiconductor device, such as a die, to a substrate by (a) applying an adhesive composition of the invention to the substrate, the semiconductor device or both the substrate and the semiconductor device; (b) contacting the substrate and the semiconductor device to form an assembly, where the substrate and the electronic component are separated only by the applied adhesive composition; and (c) curing the applied adhesive composition, thereby attaching the semiconductor device to the substrate

In still further embodiments, the invention provided b-stageable type methods for adhesively attaching a semiconductor die to a substrate. Such methods can be performed, for example, by (a) applying an invention adhesive composition to the substrate, the semiconductor device or both the substrate and the semiconductor device; (b) melting the adhesive composition applied in step (a); (c) contacting the semiconductor device and the substrate, such that the die and substrate are separated only by the applied adhesive composition; and (d) curing the applied adhesive composition, thereby attaching the semiconductor device to the substrate.

The following examples are intended only to illustrate the present invention and should in no way be construed as limiting the subject invention.

All of the structures shown in the below examples are considered to be only representative of the species present and are not intended to be an exact depiction of all of the possible oligomers. Thus, where more than one monomer is co-polymerized with AGE, the examples shown do not necessarily include all of the possible monomer sequences that are likely to be present in the final oligomer.

### EXAMPLES

### Example 1

### Preparation of Compound C-1

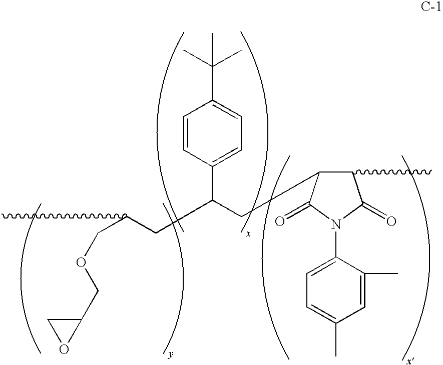

A 500 mL, two-neck flask was equipped with a magnetic stir bar, liquid inlet, argon inlet, condenser and a bubbler. The flask was swept with argon and heated in an oil bath to 155° C. A solution of 2,4-dimethylphenyl maleimide (40.24 g; 0.2 moles), t-butylstyrene (32.0 g; 0.2 moles), allylglycidyl ether (91.4 g; 0.8 moles), and 8.2 g of dicumyl peroxide was dripped into the flask via a peristaltic pump over the course of four hours. The stirring was continued another half hour at the bath temperature of 155° C. The bath temperature was then lowered to 80° C. and the flask was equipped with a distillation head. The residual allylglycidyl ether (AGE) was removed via aspirator vacuum. The bath temperature was increased in stages up to 180° C. A total of 35.9 g of crude, unused, AGE was recovered. The liquid oligomer was sparged with Argon for forty minutes while still at the high bath temperature. The product was then dumped out onto non-stick aluminum foil while still hot. The product set up to a clear, glassy, light-yellow solid. Thermogravimetric analysis (TGA) was preformed (ramp rate of 10° C. per minute with an air purge) on the neat compound and revealed a weight loss of 0.3% at 200° C. and 3.7% at 300° C. Fourier Transform Infrared spectroscopy (FTIR) was performed on the compound and significant absorptions were found at 2958, 1708, 1509, 1381, 1191, 1102, 836, and 731 wavenumbers.

Analysis of the Epoxy Oligomer. An epoxy equivalent weight (EEW) titration was performed on the solid compound and was found to be 415 g/equivalent. A 1:1:1 equivalent ratio of “x, x′, and y” in structure C-1 (above) would have been expected to give an EEW of 478 g/equivalent. A sample of this resin was cured using an imidazole catalyst, powdered and extracted with deionized water in a Parr bomb at 165° C. Analysis by ion chromatography showed a chloride content of only 10 ppm chloride in the water extract. A sample of this resin was cured using an imidazole catalyst, powdered and extracted with deionized water in a Parr bomb at 165° C. Analysis by ion chromatography showed a chloride content of only 10 ppm chloride in the water extract.

### Example 2

### Preparation of Compound C-2

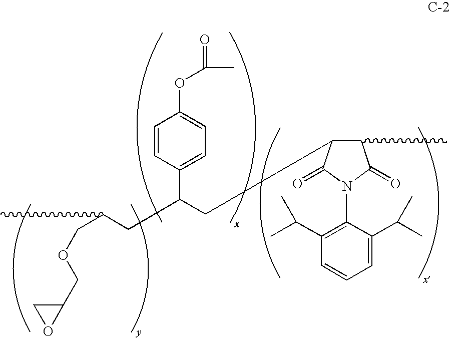

A solution was prepared containing 25.73 g (0.1 mole) 2,6-diisopropylphenyl maleimide, 16.22 g (0.1 mole) 4-acetoxystyrene, 80.0 g (0.7 mole) AGE, and 6.2 g dicumyl peroxide. The solution was dripped into a two-neck, 500 mL flask suspended in an oil bath controlled at 155° C., as in Example 1. The addition was conducted over a 3.1 hour period and the heating was continued for another half hour. The AGE was removed as in Example 1 to yield 72.3 grams of a friable, yellow, clear, glassy solid. A TGA (ramp rate of 10° C. per minute with an air purge) was run on the neat compound and was found to have a weight loss of 0.7% at 200° C. and 4.4% at 300° C. with a decomposition onset of 374° C. An FTIR performed on this oligomer and was found to have absorptions at 2928, 1763, 1707, 1506, 1453, 1373, 1189, 1099, 1016, 910, 849, 805, and 747 wavenumbers. An equivalent weight analysis indicated an EEW of 326 g per equivalent.

### Example 3

### Preparation of Compound C-3

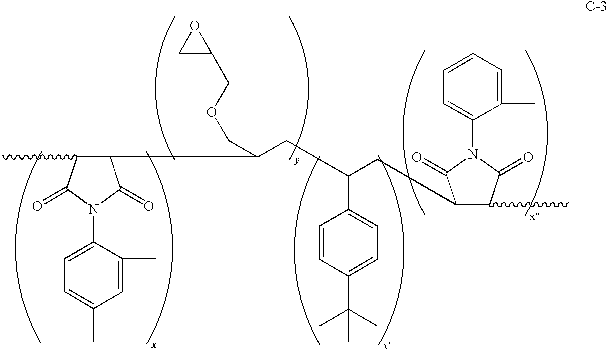

A method similar to that of Example 1 was used to make the oligomer represented above as C-3. A solution consisting of t-butylstyrene (32.0 g; 0.2 mole), 2-methylphenyl maleimide (18.7 g; 0.1 mole), 2,4-dimethylphenyl maleimide (20.1 g; 0.1 mole), AGE (160.0 g; 1.4 mole), and 11.54 g dicumyl peroxide was added to an argon blanketed, 500 mL flask at 155° C. over a 4.5 hour period. Heating was continued for another fifteen minutes and the AGE excess was removed to yield 142.9 grams of a light-yellow glassy solid. A TGA was performed on the neat product and it was found to have a weight loss of 1.5% at 200° C. and 7.3% at 300° C., with a decomposition onset of 364° C. An FTIR was performed on the oligomer which revealed absorptions at 2927, 1709, 1455, 1382, 1189, 1098, 909, 837, and 758 wavenumbers. The EEW was determined to be 307 g/equivalent.

A second preparation of this material was performed by the same method. The EEW for the second synthesis was determined to be 313 g per epoxy equivalent.

### Example 4

### Preparation of Compound C-4

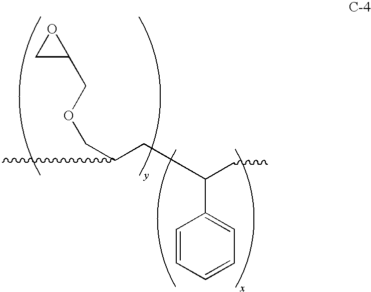

A method similar to that described above in Example 1 was used to prepare the compound C-4 (shown above). A solution containing AGE (1376 g; 12.05 moles), styrene (247.1 g; 2.37 moles), and 98.4 grams dicumyl peroxide was pumped into a three liter flask that was heated externally to 155° C. over the course of 7.25 hours. Heating at 155° C. was continued another twenty minutes and the flask was cooled to 70° C. The bulk of the AGE excess was removed under vacuum. The residual AGE was removed via a 5.5 hour argon sparge at 175° C. An almost colorless, non-tacky, glassy solid was recovered. A TGA run on the neat compound revealed a weight loss of 2.1% at 200° C. and 8.9% at 300° C. An FTIR run on the oligomer revealed absorptions at 3026, 2926, 2854, 1601, 1493, 1452, 1104, 909, 844, 758, and 698 wavenumbers. An equivalent weight analysis of this product revealed an EEW of 282 g per equivalent.

A second batch prepared according to the same procedure had an EEW of 278.

### Example 5

### Preparation of Compound C-5

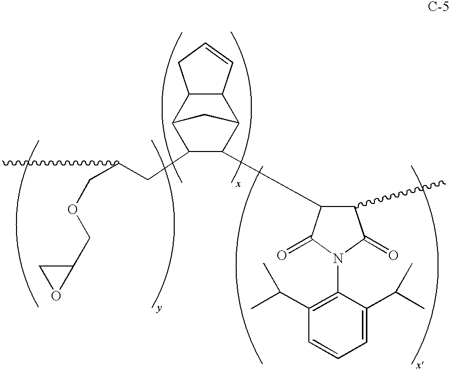

A similar method as described in the previous Examples was used to prepare the oligomer shown above as C-5. The original solution pumped into the reaction flask consisted of dicyclopentadiene (26.4 g; 0.2 mole), 2,6-diisopropylphenyl maleimide (51.2 g; 0.2 mole), AGE (160 g; 1.4 moles), and 11.9 g of dicumyl peroxide. The addition/reaction time at 155° C. was 4.25 hours plus another twenty-five minutes at this temperature. The synthesis yielded 115.3 grams of a clear, glassy, non-tacky, orange solid. A TGA run on the neat compound revealed a weight loss of 0.9% at 200° C. and 7.8% at 300° C. An FTIR run on this oligomer revealed absorptions at 2963, 1703, 1451, 1374, 1187, 1098, 909, 884 and 746 wavenumbers. The EEW measured on this oligomer was 331 g/equivalent.

### Example 6

### Preparation of Compound C-6

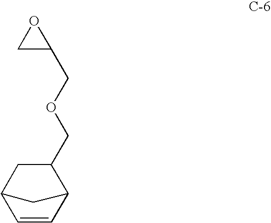

A two-neck, 500 mL flask was charged with 30.0 g AGE and a stir bar. The flask was equipped with an argon inlet, liquid inlet, condenser and bubbler. The flask was blanketed with argon and heated in an external bath to 180° C. A solution of 130 g AGE (total moles AGE=1.4) and dicyclopentadiene (66.1 g; 0.5 mole) was added over a 3.5 hour period and then stirring and heating were continued for another 1.25 hours. The excess AGE was distilled off (104.4 grams was recovered). The product (82.5 g, or 46% of the theoretical yield based on the DCPD charged) was recovered as a mobile, yellow liquid. The product had major IR absorptions at 3056, 2959, 2866, 1337, 1252, 1100, 909, 836, and 720 wavenumbers.

### Example 7

### Preparation of Compound C-7

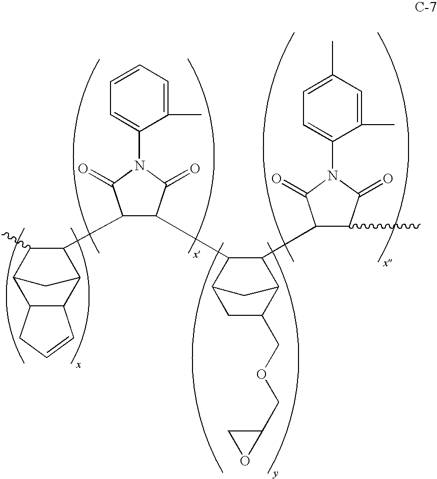

A solution containing dicyclopentadiene (11.37 g; 0.086 mole), the C-6 monomer from the previous example (31.0 g; approximately 0.172 mole), 2-methylphenyl maleimide (16.0 g; 0.086 mole), 2,4-dimethylphenyl maleimide (17.3 g; 0.086 mole), and 3.8 g dicumyl peroxide was combined as described in the previous Examples at 155° C., under argon, over 2.33 hours. The synthesis yielded 70.85 g of a dark-orange, friable, glassy solid. The neat product had 9.5% weight loss at 300° C. and a decomposition onset at 402° C. The oligomer had prominent FTIR absorptions at 2951, 1700, 1496, 1374, 1179, 1100, 755, and 718 wavenumbers. The EEW measured for this compound was 557 g per equivalent.

### Example 8

### Preparation of Compound C-8

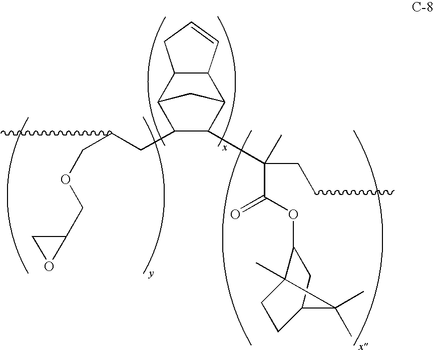

An epoxy functional oligomer represented by the above structure was made according to the same general method described above in the previous Examples. A solution of dicyclopentadiene (26.44 g; 0.2 mole), isobornyl methacrylate, AGE (160 g; 1.4 mole), and 11.55 g dicumyl peroxide was introduced to an argon-blanketed flask heated to 155° C. over a five hour period. A total of 89.8 g of a clear, yellow, extremely viscous, tacky semi-solid was recovered. An FTIR run on the product revealed prominent absorptions at 2951, 1717, 1455, 1390, 1098, 1052, 1003, 910, 844, and 762 wavenumbers. A TGA performed on the neat oligomer revealed a weight loss of 1.76% at 200° C. and a decomposition onset at 331° C. The epoxy equivalent weight was found to be 309 g/equivalent.

### Example 9

### Preparation of Compound C-9

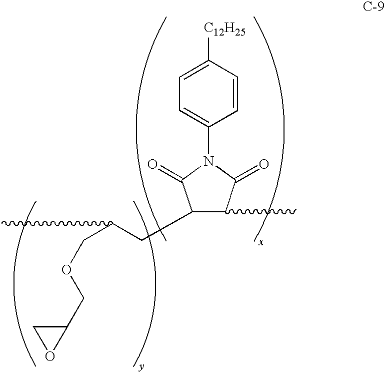

A similar method was used to prepare the epoxy oligomer approximately corresponding to structure C-9 above. A solution of 4-dodecylphenyl maleimide (51.2 g; 0.15 mole), AGE (57.1 g; 0.5 mole), and 5.4 g dicumyl peroxide was oligomerized as described in the previous Examples. A clear, red, taffy-like solid weighing 85.1 g was recovered. A TGA performed on the neat compound revealed a 4.75% weight loss by 300° C. and a decomposition onset of 400° C. An FTIR on the oligomer revealed prominent absorptions at 2930, 1708, 1514, 1381, 1185, 1098, and 833.93 wavenumbers. An epoxy equivalent weight measurement on this material indicated 432 g per equivalent. The theoretical EEW for the C-9 compound was calculated at 458.

A sample of this material was cured in the presence of two weight percent undecylimidazole. The cured sample was found to have a T_{g} of 99.9° C. via TMA. The thermal expansion coefficient below the glass transition was 74.6 ppm per degree C. and 187.3 ppm per degree C. above it.

### Example 10

### Compositions and Adhesion of Adhesives Containing Epoxy Functional Oligomers

Several adhesive compositions were formulated to test epoxy functional oligomers described in the previous examples. These compounds were formulated into UV “b-stageable” pre-applied adhesive test compositions. These compositions were applied as liquid pastes in thin films on ceramic substrates. The films were cured to a thermoplastic state via a short UV exposure to give coatings that were non-tacky at room temperature. Silicon dice were placed on these coated substrates at a bonding temperature of 140° C. The parts were then cured to a thermoset adhesive in an oven set to 175° C. A description of those formulations and the corresponding die shear adhesion results can be found in Table 1.

TABLE 1
Pre-applied Adhesive Compositions and Hot Die Shear Adhesion

| | Example | | | | | |
|---|---|---|---|---|---|---|
| Component | 10 | 11 | 12 | 13 | 14 | Comparative Example |
| Tactix ™ 756^{a} | | | | | | 37.7% |
| C-1 | 28.4% | | | | | |
| C-2 | | 40.3% | | | | |
| C-3 | | | 40.3% | | | |
| C-5 | | | | 40.3% | | |
| C-9 | | | | | 37.4% | |
| C-36 tetraphenol^{b} | 3.9% | 11.0% | 11.0% | 11.0% | 5.1% | 10.5% |
| C-36 tetra acetate^{b} | 3.9% | | | | 5.1% | — |
| QM-57^{c} | 12.5% | 15.4% | 15.4% | 15.4% | 15.5% | 27.0% |
| Acetoxyphenethyl acrylate^{d} | 2.45% | 3.0% | 3.0% | 3.0% | 3.0% | 5.0% |
| A186 Coupling | 0.72% | 0.9% | 0.9% | 0.9% | 0.9% | 0.9% |
| Agent^{e} | | | | | | |
| GF-20 Coupling | 0.72% | 0.9% | 0.9% | 0.9% | 0.9% | 0.9% |
| Agent^{e} | | | | | | |
| Esacure 100F^{f} | 1.6% | 2.0% | 2.0% | 2.0% | 2.0% | 2.0% |
| Irgacure 819^{f} | 1.6% | 2.0% | 2.0% | 2.0% | 2.0% | 2.0% |
| Curezol 2MZ azine^{g} | 0.77% | 1.0% | 1.0% | 1.0% | 1.0% | 1.0% |
| Curezol 2PZ^{g} | 0.77% | 1.0% | 1.0% | 1.0% | 1.0% | 1.0% |
| Styrene^{h} | 35.3% | 13.4% | 13.4% | 13.4% | 17.0% | 2.85% |
| R8200ⁱ | 0.93% | 1.15% | 1.15% | 1.15% | 1.15% | 1.15% |
| F3101^{j} | 6.45% | 8.0% | 8.0% | 8.0% | 8.0% | 8.0% |
| Die Shear Adhesion^{k} (kgf) on | 11.2 ± 4 | 10.8 ± 3.8 | 15.2 ± 4.7 | 10.8 ± 4.1 | 6.7 ± 2 | 8.5 ± 2.6 |
| 300 × 300 × 14 mil silcon die | | | | | | |
| at 260° C. | | | | | | |

Notes:
^{a}A polyfunctional epoxy oligomer (dicyclopentadiene-based polyepoxide resin, having an epoxide equivalent weight of from 245 to 265 grams/equivalent; Huntsman Advanced Materials Americas, Inc., Brewster, N.Y.);
^{b}In-house flexible curatives based on a dimerdiol backbone;
^{c}A mono-functional Methacrylate monomer (2-propenoic acid, 2-methyl-, 2-[(3a,3,4,5,6,7,7a-hexahydro-4,7-methano-1H-indenyl)oxy]ethyl ester; Rohm and Haas Co., Philadelphia, Pa.);
^{d}A hybrid acrylate and epoxy curative;
^{e}Commercial silane coupling agents: A186 (epoxy cyclohexyl trimethoxy silane; GE Silicones, Wilton, CT); GF-20 (3-(Triethoxysilyl)propyl succinic anhydride; Wacker Silicones, Burghausen, Germany);
^{f}Photoinitiators: Esacure 100F (oligomeric alpha hydroxy ketone and 2-hydroxy-2-methyl-phenyl 1-propane; Ciba Specialty Chemicals, Basel, Switzerland); Irgacure 819 (bis(2,4,6-trimethylbenzoyl)-phenylphosphine oxide; Ciba Specialty Chemicals, Basel, Switzerland);
^{g}Imidazole-based epoxy cure catalysts: Curezol 2MZ azine (6-[2-(2-Methyl-imidazol-1-yl)-ethyl]-[1,3,5]triazine-2,4-diamine, Air Products and Chemicals, Allentown, PA); Curezol 2PZ (2-Phenyl-1H-imidazole, Air Products and Chemicals, Allentown, PA);
^{h}A reactive diluent used to adjust the viscosity of the composition;
ⁱA fumed silica (hexamethyldisilazane treated silica, Degussa Corporation, Parsippany, NJ);
^{j}Silica filler;
^{k}All adhesion testing was done using a Dage 4000 die shear tester. The adhesive was first photo-cured using a five minute UV exposure to yield tack-free thermoplastic coatings on the ceramic substrates. Die attach was done on a heated stage set at 140° C. The parts were then cured at 175° C. for one hour in an oven.

The results summarized in Table 1 demonstrate that it is possible to achieve die shear adhesion approximately equal or superior to that obtained using a commercially available, high performance, poly-epoxy compound using the oligomers of this invention. Tactix™ 756 (dicyclopentadiene-based polyepoxide resin, having an epoxide equivalent weight of from 245 to 265 grams/equivalent; Huntsman Advanced Materials Americas, Inc., Brewster, N.Y.) is made via the reaction of epichlorohydrin with a cresol-dicyclopentadiene novolac resin. It is difficult to control the extractable chloride content in epoxy compounds, and especially in polyfunctional epoxies made via this route since the best available methods involve the use of strong base to close chlorohydrin resides back to the desired glycidyl ethers. Base is also a catalyst for the cure of these same epoxies and so it is difficult to reduce the chloride to levels acceptable for use in microelectronic applications without also polymerizing the epoxy oligomer in the process. The oligomers of this invention take advantage of the availability high purity allyl glycidyl ether, which is a commercially available, low chloride source of glycidyl ether epoxy functionality. The polyfunctional monomers of the present invention have the inherent advantage of low chlorine content and are therefore more suitable for use in microelectronic applications. The oligomers of this invention have a significant further advantage in that their properties can be tailored to fit various modulus, glass transition, and polarity requirements. A wide variety of olefinically unsaturated monomers can be used and combined to create a large new toolbox of useful, epoxy functional thermoset monomers.

While this invention has been described with respect to these specific examples, it should be clear that other modifications and variations would be possible without departing from the spirit of this invention.

1. An oligomeric epoxy compound having the structure of formula I: 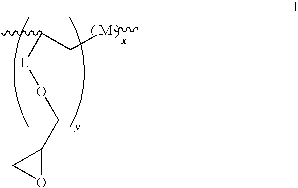
wherein:
each M is independently a monomer selected from an acrylate; a methacrylate, a styrenic, a maleimide, a vinyl ester, a vinyl ether, a fumarate, a maleate, an itaconate, a norbornene, a dicylcopentadiene, an indene, an olefin, a cyclic olefin, an allyl oxetanyl ether, a vinyl oxetanyl ether, an oxetanyl, an acrylate, a methacrylate, an acrylonitrile, a methacrylonitrile, an acrylamide, a methacrylamide a N,N-dimethyl acrylamide, and a phenyl acetate:
L is an alkylene oxyalkylene, cycloalkylene or is absent; and
each x and y is independently 3 to about 100.

2. The oligomeric epoxy compound of claim 1, wherein at least one M is a cyclic olefin, a styrenic, an acrylate or a methacrylate.

3. The oligomeric epoxy compound of claim 2, wherein the cyclic olefin is a norbornene, a norbornadiene, or an oligomer of cyclopentadiene.

4. The oligomeric epoxy compound of claim 3, wherein the oligomer of cyclopentadiene is a dicyclopentadiene, a tricyclopentadiene, a tetracyclopentadiene, or a tetracyclododecene.

5. The oligomeric epoxy compound of claim 1, wherein at least one M is an acetoxystyrene, a 4-acetoxyphenethyl acrylate, or a 4-acetoxyphenethyl vinyl ether.

6. (canceled)

7. The oligomeric epoxy compound of claim 2, wherein the styrenic is 4-tert-butylstyrene.

8. The oligomeric epoxy compound of claim 1, wherein at least one M is a 2-hydroxyethyl acrylate, a 2-hydroxyethyl methacrylate, a hydroxypropyl acrylate, a hydroxypropyl methacrylate, a 4-hydroxybutyl acrylate, a 2-hydroxyethyl acrylamide, a 2-hydroxyethyl methacrylamide, an N-methylol methacrylamide, glycidyl methacrylate, a glycidyl vinyl ether, a (3-ethyl-3-oxetanyl)acrylate, a (3-ethyl-3-oxetanyl)methacrylate, a (3-ethyl-3-oxetanyl)vinyl ether, a (3-ethyl-3-oxetanyl)allyl ether, a furfuryl acrylate, a cyclohexanedimethanol monovinyl ether, a butanediol monovinyl ether, or a furfuryl methacrylate.

9. The oligomeric epoxy compound of claim 1, wherein each x and y is independently about 20 to about 75.

10. The oligomeric epoxy compound of claim 1, wherein the compound is a block co-oligomer, a random co-oligomer, or an alternating co-oligomer.

11. (canceled)

12. (canceled)

13. The oligomeric epoxy compound of claim 1, having a structure selected from formula II, III and IV. 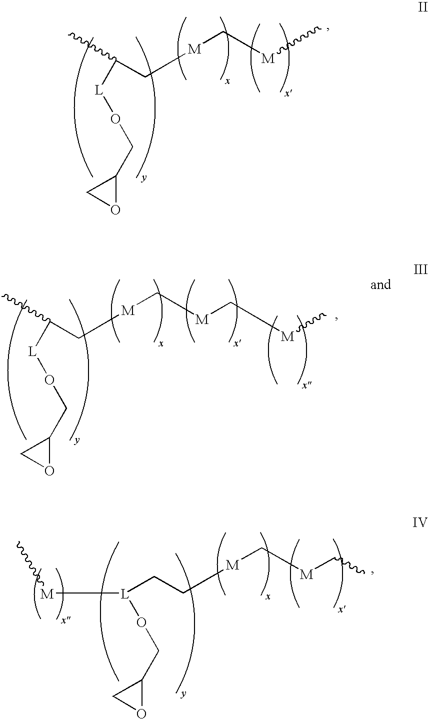
wherein:
each M is independently a monomer selected from an acrylate, a methacrylate a styrenic, a maleimide, a vinyl ester, a vinyl ether, a fumarate, a maleate, an itaconate, a norbornene, a dicylcopentadiene, an indene, an olefin, a cyclic olefin, an allyl oxetanyl ether, a vinyl oxetanyl ether, an oxetanyl, an acrylate, a methacrylate, an acrylonitrile, a methacrylonitrile, an acrylamide, a methacrylamide a N,N-dimethyl acrylamide, and a phenyl acetate;
L is an alkylene, oxyalkylene, cycloalkylene or is absent; and
each x, x′, x″ and y is independently 3 to about 100.

14. The oligomeric epoxy compound of claim 1, wherein L has 2 to about 20 carbon atoms.

15. An oligomeric compound selected from: 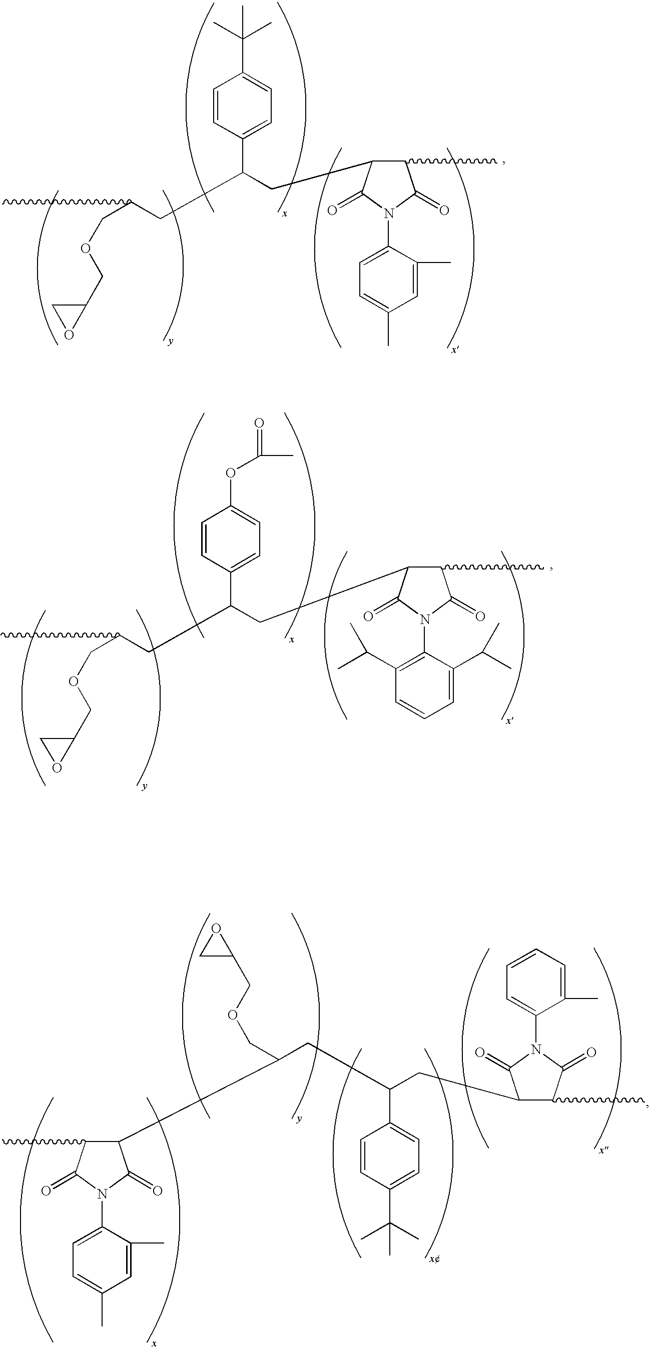 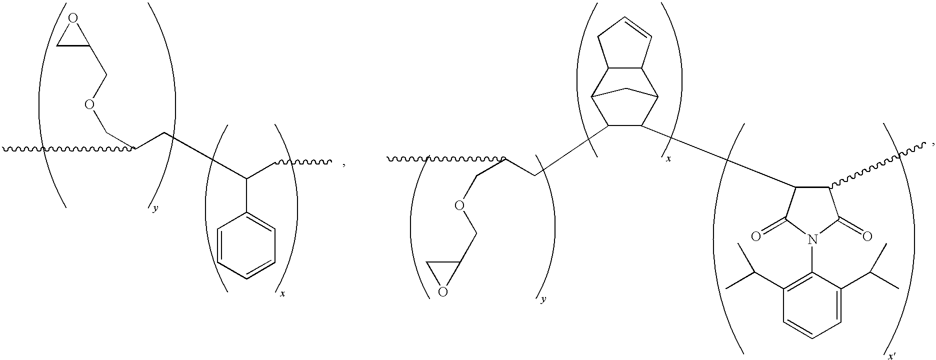 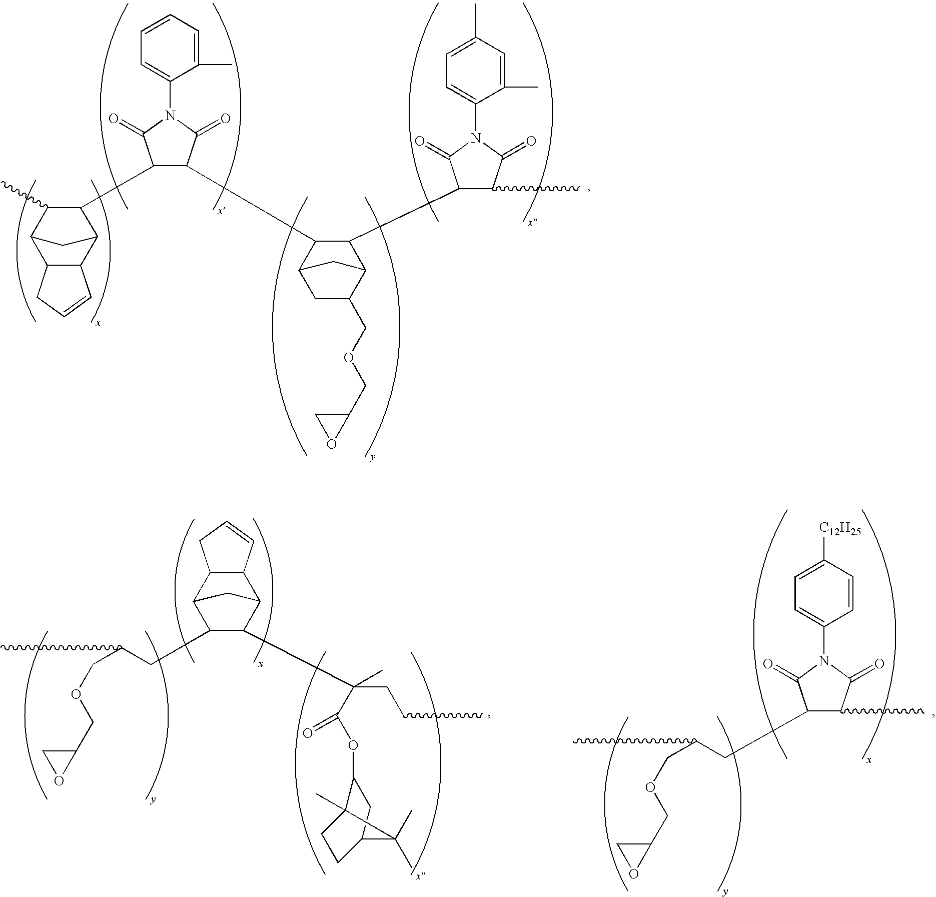 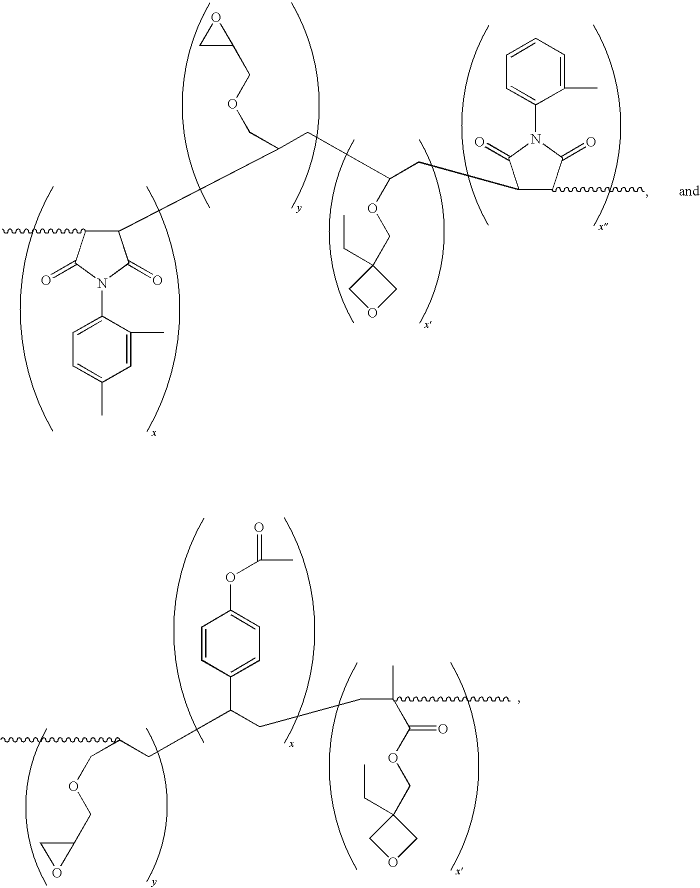
wherein each x, x′, x″ and y is independently 3 to about 100.

16. A adhesive composition comprising:
(a) at least one oligomeric epoxy compound of claim 1, and
(b) 0.1 to about 5 wt % of at least one curing catalyst, based on the total weight of the composition.

17. (canceled)

18. (canceled)

19. (canceled)

20. (canceled)

21. (canceled)

22. The adhesive composition of claim of claim 16, wherein the at least one curing catalyst is a tertiary amine, a quaternary ammonium compound, a phosphine, phosphonium compound, an alkali metal hydroxide or a Lewis acid.

23. The adhesive composition of claim of claim 22, wherein the at least one curing catalyst is a triethylamine, a tripropylamine, a tributylamine, a N,N-dimethylbenzylamine, a dimethylaminopyridine, a DBU, a DABCO, a 2-methylimidazole, a N-methylmorpholine, an epoxy amine adduct, a benzyl trimethyl ammonium chloride, a tetrabutylammonium chloride, a triphenylphosphine, a tributylphosphine, a trilaurylphosphine, a trichlorobutylphosphine, a trinaphthylphosphine, an ethyltriphenylphosphonium chloride, an ethyltriphenylphosphonium bromide, an ethyltriphenylphosphonium iodide, an ethyltriphenylphosphonium phosphate, an ethyltriphenylphosphonium acetate-acetic acid complex, a tetrabutylphosphonium chloride, a tetrabutylphosphonium bromide, a tetrabutylphosphonium iodide, a tetrabutylphosphonium phosphate, a tetrabutylphosphonium acetate acetic acid complex, a butyltriphenylphosphonium tetrabromobisphenate, a butyltriphenylphosphonium bisphenate, a butyltriphenylphosphonium bicarbonate, sodium hydroxide, potassium hydroxide, lithium hydroxide, a boron trifluoride etherate, a boron trifluoride amine salts, a tin carboxylate, or a zinc carboxylate.

24. (canceled)

25. (canceled)

26. The adhesive composition of claim 16, further comprising about 10 wt % to about 90 wt % of at least one co-curing compound selected from an epoxy, an acrylate, a methacrylate, a maleimide, a poly-phenol compound, an anhydride, a dianhydride, a polyanhydride, an imide, a carboxylic acid, a dithiol, a polythiol, a phenol functional mono-maleimide, a bismaleimide, a polymaleimide, a mono-itaconate, a mono-maleate, a mono-fumarate, an acrylic acid, a methacrylic acid, a cyanate ester, a vinyl ether, a vinyl ester, a phenol functional ester, a urea, an amide, a polyolefin, a cyanoacrylate, an allyl functional compound, a styrenic, an epoxy of a glydicyl ether of an alcohol, an epoxy of a glydicyl ether of a phenol, an epoxy of a glydicyl ether of a bisphenol, an epoxy of a glydicyl ether of an oligomeric phenolic, an epoxy of a glydicyl ether of a phenolic novolac, an epoxy of a glydicyl ether of a cresolic novolac, a styrene-maleic anhydride co-polymer, an amine functional polyolefin, a carboxylic acid functional polyolefin, a hydroxy functional polyolefin, an epoxy functional polyolefin, an epoxy functional siloxane, a phenolic functional siloxane, a carboxylic acid functional siloxane, and a thiol functional siloxane.

27. (canceled)

28. The adhesive composition of claim 16, further comprising at least one of a phototoinitiator, a thermal initiator, both a phototoinitiator and a thermal initiator, a reactive diluent, a filler, a coupling agent, a curative, and a monomer selected from an acrylate, a methacrylate, a maleimide, a vinyl ether, a vinyl ester, a styrenic compounds and an allyl functional compound.

29. (canceled)

30. (canceled)

31. (canceled)

32. (canceled)

33. (canceled)

34. The adhesive composition of claim 28, wherein the coupling agent is a silicate ester, a metal acrylate salt, a titanate, a zirconate, or a compound that contains a copolymerizable group and a chelating ligand.

35. The adhesive composition of claim 28, wherein the coupling agent comprises:
(a) a co-polymerizable function selected from a vinyl moiety, a acrylate moiety, a methacrylate, a epoxy, a thiol, a anhydride, an isocyanate, and a phenol moiety; and
(b) a silicate ester function.

36-47. (canceled)
